(19) United States
(12) Patent Application Publication
(10) Pub. No.: US 2010/0175492 A1
(43) Pub. Date: Jul. 15, 2010

(54) POWER BOOSTING DEVICE

(75) Inventors: Klaus Spaeth, Berg (DE); Dieter Fischer, Nonnenhorn (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/602,279

(22) PCT Filed: May 27, 2008
(86) PCT No.: PCT/EP2008/056457

§ 371 Date: Nov. 30, 2009

(30) Foreign Application Priority Data
Jun. 6, 2007 (DE) 10 2007 026 421.8

(51) Int. Cl. F16H 59/02; F15B 13/04

(52) U.S. Cl. 74/473.11; 91/422

(57) ABSTRACT

A servo-assistance mechanism (10) comprises an element (20) upon which a manual shifting force to be assisted acts. The servo-assistance mechanism (10) further comprises at least one valve piston (40, 48), arranged on the element (20), and at least one device (58, 60), for limiting the servo-assistance force. The valve piston (40, 48) comprises a first valve piston (42, 50) and a second valve piston (44, 52), and the first valve piston (42, 50) co-operates with the device (58, 60) for limiting the servo-assistance force and is arranged and radially sealed inside the second valve piston (44, 52).

This application is a National Stage completion of PCT/EP2008/056457 filed May 27, 2008, which claims priority from German patent application serial no. 10 2007 026 421.8 filed Jun. 6, 2007.

### FIELD OF THE INVENTION

The invention concerns a servo-assistance mechanism, in particular for a shifting device of a motor vehicle transmission.

### BACKGROUND OF THE INVENTION

Present-day utility vehicles, such as omnibuses and trucks, with their forward control design, provide transmission fitting space such that the transmission is necessarily far removed from the driving seat. The distance is particularly large in vehicles with under-floor or rear-mounted engines. Owing to the long and sometimes stiffly moving shift linkage in mechanically shifted transmissions, accurate gearshifts are often made more difficult.

To allow the driver of a motor vehicle to focus his attention completely on the road traffic, he must be assisted and supported as much as possible in all the activities required for driving the motor vehicle.

Every driver knows how decisively important it can be, to be able to operate the transmission without difficulty in difficult traffic situations. In this respect pneumatic shift aids for utility vehicles of any size can be helpful.

Previously known servo-shifting devices are partially built directly onto the transmission and comprise a control rod accessible from outside, and piston rods. The shift linkage is connected to the control rod. The assistance mechanism is activated by a longitudinal movement of the control rod. This type of control is found in combination with two rod or cable shifts. A disadvantage here is the sealing of the control and piston rods by bellows and the lack of lubrication. In trucks the point concerned is exposed to much dirt. When the shift linkage ratio is changed, the beginning of the servo-assistance also changes or it has to be adapted to the linkage ratio by modifying the valve. The same applies to shift aids that consist of a control valve and a servo-cylinder separate from one another. The valve and cylinder are connected, via ball joints, to the shift lever and a cantilever, which is in turn fixed on the transmission. This arrangement has the added disadvantage that during every shift the components move relative to the transmission and the vehicle's chassis, so the air lines by which the valve and the cylinder are connected to one another can be perforated by chafing.

Such pneumatic shift aids are also known in a divided configuration, consisting of a mechanical-pneumatic control portion and a separate, pneumatic force portion. A shift aid of divided configuration is known from Loomann; Zahnradgetriebe (Geared transmissions); 2nd edition; Springer Verlag; 1988; p. 225. The control portion is a mechanically actuated control valve, which is actuated by the shift linkage. In this case movement of the selection lever during gearshifts is transmitted mechanically directly to the transmission. When the shifting movement is transmitted, the control valve is actuated and at the same time the manual shifting force is transferred by a lever to the transmission. The manual shifting force is additionally assisted pneumatically by a compressed-air cylinder. This compressed-air cylinder, which is a two-position cylinder with an integrated hydraulic damper, forms the pneumatic force portion. In this case the manual shifting force is not reflected directly proportionally. The paths between the control and force portions are long, and the structure takes up considerable space. Damage of the compressed-air lines between the control and force portions cannot be avoided.

In the not previously published application with file number 10 2006 006 652 by the present applicant, a shifting device with a servo-assistance mechanism for a vehicle transmission is disclosed, which comprises means for selecting and engaging a gear of the transmission and a control rod of the servo-assistance mechanism, upon which the manual shifting force to be assisted acts. In the servo-assistance mechanism spring elements are provided in order to vary the manual shifting force that acts upon the servo-assistance mechanism, within the servo-assistance mechanism, before and/or during the production of the servo-assistance force, thereby influencing the servo-assistance mechanism in its action. The spring elements co-operate with actuating or valve pistons, whereby the servo-assistance force can be limited internally.

However, this servo-assistance mechanism has the disadvantage that its design principle cannot be arbitrarily transferred for use with actuating or valve pistons with large diameters, since in the case of large actuating piston or valve piston diameters the spring elements that act on the pistons must be designed to be correspondingly strong. The loading of components upon which the spring forces act is then very high and the life of those components is accordingly reduced.

### SUMMARY OF THE INVENTION

The purpose of the present invention is to indicate a servo-assistance mechanism, in particular for a shifting device of a motor vehicle transmission, with which the servo-assistance force can be limited internally even when valve pistons with large piston diameters are used, and in which the loading of the components upon which the corresponding means for limiting the servo-assistance force act, is low.

The objective addressed by the invention is achieved by a servo-assistance mechanism of the general type described, which also embodies the characterizing features of the principal claim.

The servo-assistance mechanism according to the invention, in particular for a shifting device of a motor vehicle transmission, comprises an element upon which a manual shifting force to be assisted acts, at least one valve piston arranged on the element and at least a means for limiting the servo-assistance force within the servo-assistance mechanism. According to the invention the valve piston as a whole consists of a first valve piston and a second valve piston, the first valve piston co-operating with at least one means for limiting the servo-assistance force and being arranged inside the second valve piston in a radially sealing manner.

In a preferred embodiment of the servo-assistance mechanism according to the invention, the element on which the manual shifting force to be assisted acts is in the form of a control rod of the servo-assistance mechanism and the means for limiting the servo-assistance force are in the form of a spring element. For example, the spring element can be a spiral spring or a cup spring.

In a particularly preferred embodiment of the servo-assistance mechanism according to the invention, the first valve piston can move axially on the control rod against the spring force of the spring element. In the non-actuated condition of the servo-assistance mechanism, the first valve piston is pressed by the spring force of the spring element against an abutment of the control rod. The abutment can for example consist of a retaining ring, or it can be made integrally with the control rod. The first valve piston is arranged inside the second valve piston, preferably in such manner that when the first valve piston moves axially, only minimal frictional forces act between the first valve piston and the second valve piston.

In an advantageous embodiment of the servo-assistance mechanism according to the invention, the axial movement of the first valve piston in the direction of the spring element can be limited by a stop element. The stop element can be, for example, a retaining ring arranged fixed on the control rod, or it can be made integrally with the control rod. In an advantageous design of the second valve piston, the latter too can serve as a stop element for limiting the axial path of the first valve piston toward the spring element.

In an advantageous embodiment of the servo-assistance mechanism according to the invention, the second valve piston is pot-shaped and serves on the one hand as an abutment surface for the means for limiting the servo-assistance force and on the other hand as a cylinder for the first valve piston.

In a particularly advantageous embodiment of the servo-assistance mechanism according to the invention, a sealing means is arranged between the first and the second valve pistons in a groove on the outer diameter of the first valve piston, in order to seal the first valve piston relative to the second valve piston. The sealing means can for example consist of a sealing ring. Likewise, it is conceivable that the seal acting between the first and the second valve pistons is attached to the envelope surface of the first valve piston or to the cylinder surface of the second valve piston, for example injection-molded onto it.

In a further embodiment of the servo-assistance mechanism according to the invention, the servo-assistance mechanism comprises a piston rod that co-operates with means for engaging a gear of the change-speed transmission.

In a particularly preferred embodiment of the servo-assistance mechanism according to the invention, the second valve piston can be moved axially by means of the control rod and is arranged inside the piston rod in a radially sealing manner. For example, the second valve piston can be attached on the control rod, or held on the control rod by means of a stop element and by the spring force of the spring element that limits the servo-assistance force, in such manner that it can be moved axially by the control rod. A firm connection between the second valve piston and the control rod can be made, for example, by a push-fit connection, a threaded connection with appropriate locking means, or by a plurality of stop elements.

In an advantageous embodiment of the servo-assistance mechanism according to the invention, the second valve piston has a groove on its outer circumference, in which sealing means are arranged for sealing the second valve piston inside the piston rod. The sealing means can for example be a sealing ring.

In a further advantageous embodiment of the servo-assistance mechanism according to the invention, on its outer diameter the second valve piston has a groove in which a guiding strip is arranged in order to guide or support the control rod within the piston rod, so that there is no need for any additional mounting means for the control rod.

The shifting device according to the invention, for example a shifting device for a transmission of a motor vehicle, comprises a servo-assistance mechanism according to the invention of the type described above.

### BRIEF DESCRIPTION OF THE DRAWINGS

Below, the basic principle of the invention, which allows several embodiments, is described in greater detail with reference to drawings, which show:

FIG. 1: Shifting unit of the prior art;

FIG. 2: Sectional view of an embodiment of the servo-assistance mechanism; and

FIG. 3: Sectional view of another embodiment of the servo-assistance mechanism.

### DETAILED DESCRIPTION OF THE PREFERRED EMBODIMENTS

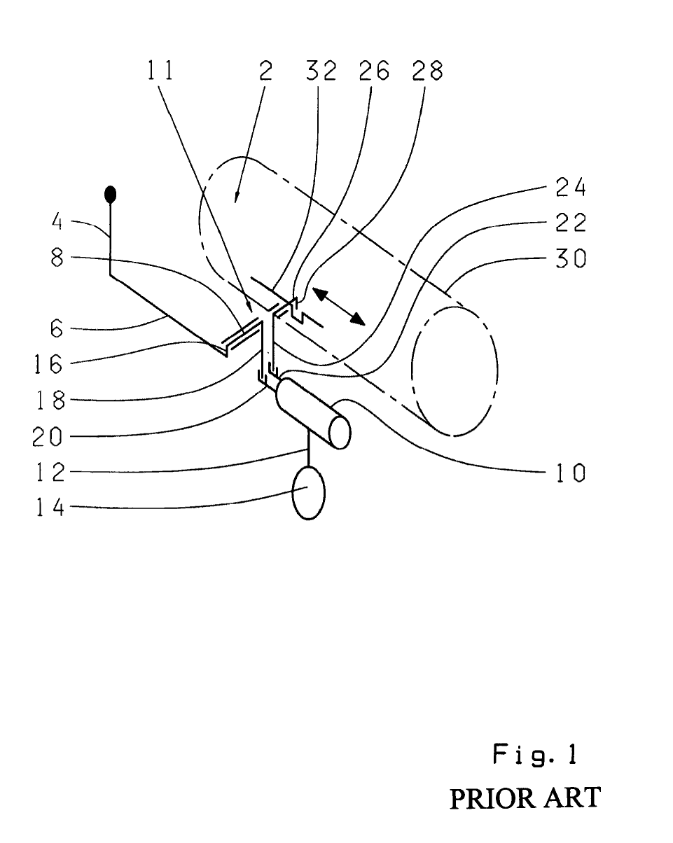

FIG. 1 is a sketch showing the shifting unit 2 of a motor vehicle, according to the prior art. From a shift lever 4 a shift rod 6 leads, via a lever deflection 8, to a shifting device 11 with a pneumatic servo-assistance mechanism 10. The pneumatic servo-assistance mechanism 10 comprises a connection line 12 leading to a reservoir container 14, from which the pneumatic servo-assistance mechanism 10 is supplied with compressed air. The lever deflection comprises a first lever 16, which is preferably articulated to the shifting rod 6. The lever deflection 8 comprises a second lever 18, which in turn engages in a control rod 20 arranged in the pneumatic servo-assistance mechanism 10. Furthermore, in the pneumatic servo-assistance mechanism 10 a piston rod 22 is provided, in which there engages a lever 24 which is connected, via a rotating shifting shaft 26, to a lever 28 in the transmission 30 of the vehicle. The lever 28 engages in a shift rail 32 by means of which, in a known way, transmission ratios of the transmission can be engaged. Movement of the lever 24 is converted by the shifting shaft 26 into movement of the lever 28, so that the lever 28 can move the shift rail 32 axially. By virtue of that movement the shift rail 32 adopts preferably three positions, namely two axial end positions each respectively corresponding to an engaged transmission ratio, and a central position between the end positions, which corresponds to a neutral setting of the transmission.

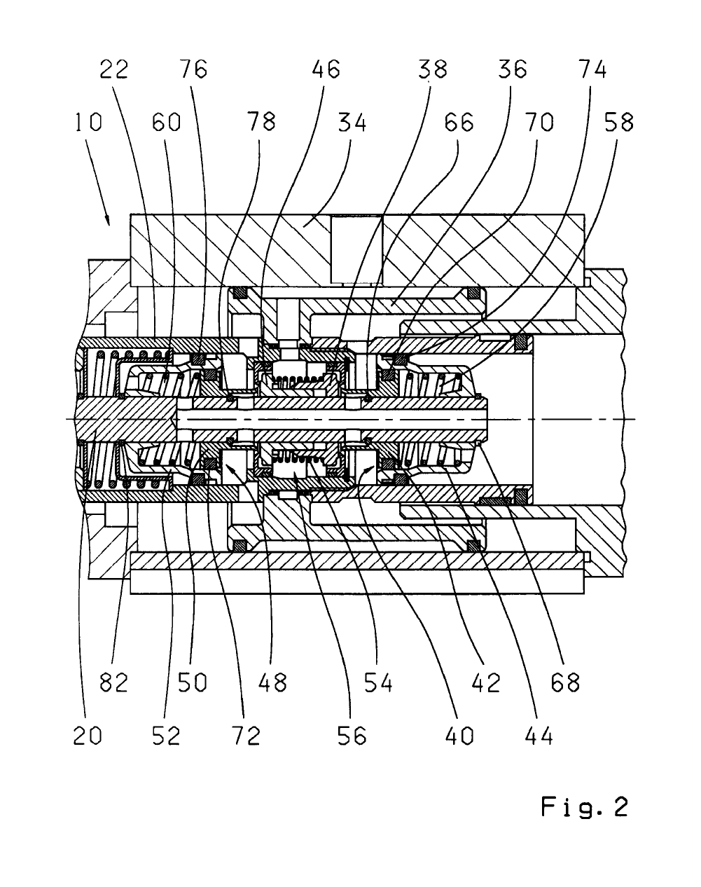

FIG. 2 shows a sectioned representation of the servo-assistance mechanism 10 according to the invention. The servo-assistance mechanism 10 comprises a control rod 20, a piston rod 22, a cylinder 34 and a piston 36. The control rod 20 of the servo-assistance mechanism 10 is arranged to move axially within the piston rod 22 and co-operates, via a shift linkage, with a shift lever (see FIG. 1). The piston 36 and the piston rod 22 are connected permanently to one another, or made as an integral component. The piston rod 22 co-operates with means for shifting the geared change-speed transmission (see FIG. 1). A valve 56 comprises valve pistons 40, 48 and valve slides 38 and 46.

According to the invention, the valve pistons 40, 48 are made in two parts and comprise a first valve piston 42, 50 and a second valve piston 44, 52. Only the first valve piston 42, 50 co-operates with a spring element 58, 60 to limit the servo-assistance force internally. In this case the spring element 58, 60 is formed as a spiral spring and can for example even be arranged in the servo-assistance mechanism 10 under pre-stress. The second valve piston 44, 52 is in this case cup-shaped and is arranged on the control rod 20. The second valve piston 44, 52 serves on the one hand as an abutment surface for the spring element 68, 60, and on the other hand as a cylinder for the first valve piston 42, 50. The first valve piston 42, 50 is fitted inside the second valve piston 44, 52. To seal the first valve piston 42, 50 relative to the second valve piston 44, 52, in this case sealing means 70, 72 are positioned between the first valve piston 42, 50 and the second valve piston 44, 52, in a groove on the outside diameter of the first valve piston 42, 50. The second valve piston 44, 52 is fitted inside the piston rod 22. To seal the second valve piston relative to the piston rod 22, sealing means 74, 76 are positioned between the second valve piston 44, 52 and the piston rod 22, in a groove on the outside diameter of the second valve piston 44, 52. By means of a stop element 68, 82 and the spring force of the spring element 58, 60, the second valve piston 44, 52 is held onto the control rod 20 in such manner that it can be moved axially by the control rod 20. Likewise, the second valve piston 44, 52 can be permanently attached to the control rod 20 by a press fit. The spring element 58, 60 is fitted inside the second valve piston 44, 52 and rests at one end against the abutment surface of the second valve piston 44, 52, and at the other end against the first valve piston 42, 50.

The first valve piston 42, 50 is arranged to move axially within the second valve piston 44, 52 on the control rod 20 and against the spring force of the spring element 58, 60. In the non-actuated condition of the servo-assistance mechanism 10 the first valve piston 42, 50 is pressed by the spring force of the spring element 58, 60 against an abutment 66, 78 of the control rod 20. The abutment 66, 78 can consist for example of a retaining ring, or it can be made integrally with the control rod 20. Between the valve pistons 40, 48 the valve slides 38, 46 too are arranged to move axially on the control rod 20. The valve slides 38, 46 are held axially apart from one another by a spring element 54 and, in the non-actuated condition of the servo-assistance mechanism 10, each rests against a respective valve seat of the piston rod 22.

If the control rod 20 is moved to the left in the plane of the drawing by a manual shifting force, the valve pistons 40, 48 on the control rod 20 are also moved to the left. The valve slide 38 is actuated by the first valve piston 42 so that it is lifted clear of the valve seat of the piston rod 22 and the valve 56 opens. Through the open valve 56 a servo-pressure is regulated in correspondence with the control rod force applied, by means of an existing reservoir pressure. This servo-pressure acts on the valve piston 40 and thus both on the first valve piston 42 and on the second valve piston 44. If, by increasing the manual shifting force, the control rod 20 is now moved farther to the left, then by virtue of the force equilibrium established the first valve piston 42 and the valve slide 38 remain in their previously reached open positions, while the control rod 20 moves farther relative to the two of them and accordingly compresses the spring element 58. Then a new force equilibrium is established, and the servo-assistance force varies accordingly. Thus, thanks to the spring element 58 the servo-assistance force can be limited internally.

Actuation of the control rod 20 to the right in the plane of the drawing produces an analogous result. In this case the valve slide 46 is actuated by the first valve piston 50, so that the valve slide 46 is lifted clear of the valve seat of the piston rod 22 and the valve 56 opens.

The spring elements 58, 60 can for example have different spring characteristics, whereby the servo-assistance force is limited to different extents in the two actuation directions of the control rod 20 since forces of different size act on the first valve piston 42, 50.

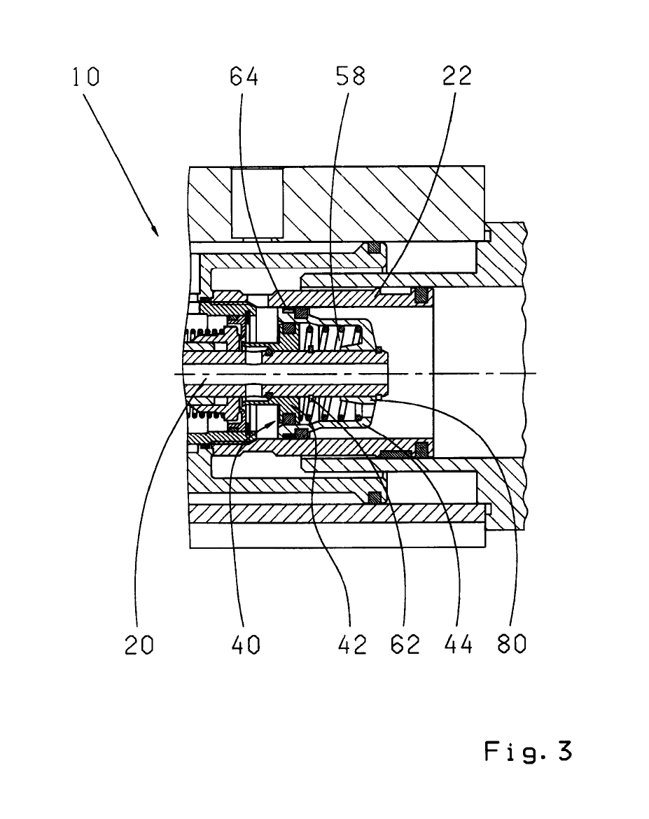

FIG. 3 shows a sectioned view of another embodiment of the servo-assistance mechanism 10 according to the invention. The same indexes are used for the components known from FIG. 2. In contrast to the embodiment described with reference to FIG. 2, in this case the axial movement of the first valve piston 42 toward the spring element 58 is limited by a stop element 62. Here, the stop element 62 is in the form of a retaining ring arranged fixed on the control rod 20. If the regulated servo-pressure now becomes large enough for the first valve piston 42 to be pushed, against the spring force of the spring element 58, onto the stop element 62, then the servo-characteristic will adopt a course that corresponds to a servo-characteristic line in which the first valve piston 42 is arranged fixed on the control rod 20. Thus, with the servo-assistance mechanism according to the invention a gate-dependent limiting of the servo-assistance force can be achieved. In an advantageous design of the second valve piston 44, the second valve piston 44 can also serve as a stop for limiting the axial path of the first valve piston 42 in the direction of the spring element 58. For this purpose, for example, the inside diameter of the second valve piston 44 can be tapered so that the axial movement of the first valve piston 42 is correspondingly limited. It is also conceivable for a collar 80 of the second valve piston 44 to be made appropriately longer and thus serve as a stop for the first valve piston 42.

On its outer diameter, the second valve piston 44 has a groove in which a guiding strip 64 is arranged. The guiding strip 64 serves to guide or support the control rod 20 within the piston rod 22.

Thanks to the servo-assistance mechanism 10 according to the invention, in which the valve piston 40, 48 is made in two parts, the servo-pressure regulated within the servo-assistance mechanism 10 acts both on the first valve piston 42, 50 and on the second valve piston 44, 52. Thus, the servo-pressure acts on a large piston area, while the spring element 58, 60 for limiting the servo-assistance force in the servo-assistance mechanism 10 only acts upon the first, smaller valve piston 42, 50. Accordingly, the spring force of the spring element 58, 60 can be made correspondingly small, so that the loading of the components on which the spring force of the spring element 58, 60 acts, such as the first valve piston 42, 50 and the stop element 66, 78, is correspondingly low. Thus, by virtue of the servo-assistance mechanism according to the invention, an internal limitation of the servo-assistance force can be achieved, such that despite the use of valve pistons 40, 48 with large piston diameters only small component loads are produced.

Thanks to the use of valve pistons with large piston diameters a servo-assistance characteristic can be produced, which has a flatter course than a characteristic that could be produced by using valve pistons with smaller diameters. Thus, compared with the use of valve pistons with smaller piston diameters, the use of ones with large piston diameters correspondingly reduces the servo-assistance force associated with any manual shifting force or control rod force.

### INDEXES

2 Shifting unit
4 Shift lever
6 Shifting rod
8 Lever deflection
10 Servo-assistance mechanism
11 Shifting device
12 Connection line
14 Reservoir container
16 Lever
18 Lever
20 Control rod
22 Piston rod
24 Lever
26 Shifting shaft
28 Lever
30 Vehicle transmission
32 Shift rail
34 Cylinder
36 Piston
38 Valve slide
40 Valve piston
42 First valve piston
44 Second valve piston
46 Valve slide
48 Valve piston
50 First Valve piston
52 Second valve piston
54 Spring element
56 Valve
58 Spring element
60 Spring element
62 Stop element
64 Guiding strip
66 Abutment
68 Stop element
70 Sealing element
72 Sealing element
74 Sealing element
76 Sealing element
78 Abutment
80 Collar
82 Stop element

1-12. (canceled)

13. A servo-assistance mechanism (10) comprising:
an element (20) upon which a manual shifting force to be assisted acts,
at least one valve piston (40, 48) arranged on the element (20), and
at least one means (58, 60) for limiting a servo-assistance force,
the valve piston (40, 48) comprising a first valve piston (42, 50) and a second valve piston (44, 52), and the first valve piston (42, 50) co-operating with the at least one means (58, 60) for limiting the servo-assistance force and being arranged inside the second valve piston (44, 52) in a radially sealing manner.

14. The servo-assistance mechanism (10) according to claim 13, wherein the element (20) is a control rod of the servo-assistance mechanism (10).

15. The servo-assistance mechanism (10) according to claim 13, wherein the means (58, 60) for limiting the servo-assistance force comprises a spring element.

16. The servo-assistance mechanism (10) according to claim 15, wherein the first valve piston (42, 50) is axially movable, on the element (20), against a spring force of the spring element (58, 60).

17. The servo-assistance mechanism (10) according to claim 16, wherein the axial movement of the first valve piston (42, 50), in a direction of the spring element (58, 60), is limited by a stop element (62).

18. The servo-assistance mechanism (10) according to claim 15, wherein the second valve piston (44, 52) is cup-shaped and serves both as a contact surface for the spring element (58, 60) and as a cylinder for the first valve piston (42, 50).

19. The servo-assistance mechanism (10) according to claim 18, wherein a sealing means, between the first valve piston (42, 50) and the second valve piston (44, 52), is arranged in a groove on an outer diameter of the first valve piston (42, 50) for sealing the first valve piston (42, 50) relative to the second valve piston (44, 52).

20. The servo-assistance mechanism (10) according to claim 13, wherein the servo-assistance mechanism (10) comprises a piston rod (22) which co-operates with a means for shifting a geared change-speed transmission.

21. The servo-assistance mechanism (10) according to claim 20, wherein the second valve piston (44, 52) is axially movable, by the control rod (20), and is arranged inside the piston rod (22) in a radially sealing manner.

22. The servo-assistance mechanism (10) according to claim 21, wherein an outer diameter of the second valve piston (44, 52) has a groove in which a sealing means is arranged for sealing the second valve piston (44, 52) relative to the piston rod (22).

23. The servo-assistance mechanism (10) according to claim 21, wherein an outer diameter of the second valve piston (44, 52) has a groove in which a guiding strip (64) is arranged for either guiding or supporting the control rod (20) inside the piston rod (22).

24. The servo-assistance mechanism (10) according to claim 13, wherein the servo-assistance mechanism (10) communicates with a shifting device (11) for a transmission (30) of a motor vehicle and provides assistance thereto.

25. A servo-assistance mechanism (10) for providing a supplemental shifting force to a manually operated shifting device (11) of a motor vehicle transmission (30), the servo-assistance mechanism (10) comprising:
a control rod (20) communicating with the manually operated shifting device (11) for supplementing a manual shifting force with the supplemental shifting force;
a hollow piston rod (22) communicating with shifting elements (24, 26, 28, 32) of the motor vehicle transmission (30), the control rod (20) being coaxially aligned with and axially slidable within the hollow piston rod (22);
at least one primary valve piston (40, 48) being supported on the control rod (20) and comprising a first valve piston (42, 50) and a second valve piston (44, 52); and
the first valve piston (42, 50) being coaxially aligned with and located within the second valve piston (44, 52), a sealing element (70, 72) sealing an outer diameter of the first valve piston (42, 50) to an inner diameter of the second valve piston (44, 52) and the first valve piston (42, 50) axially slides within second valve piston (44, 52) against a force of a spring (58, 60) which limits the supplemental shifting force.
